(19) United States
(12) Patent Application Publication
(10) Pub. No.: US 2021/0158341 A1
(43) Pub. Date: May 27, 2021

(54) Custom Three-Dimensional Financial Services Object

(71) Applicant: Wells Fargo Bank, N.A., San Francisco, CA (US)

(72) Inventors: Mike Duke, Monroe, NC (US); Kourtney Eidam, Marietta, GA (US); Andrew J. Garner, IV, State Road, NC (US)

(21) Appl. No.: 14/796,542

(22) Filed: Jul. 10, 2015

(51) Int. Cl. G06Q 20/38; G06Q 20/32; G06K 9/00

(52) U.S. Cl. CPC G06Q 20/3821; G06Q 20/3226; G06Q 2220/00; G06K 9/00087; G06Q 20/327

(57) ABSTRACT

An electronic computing device receives a scanned image of a first object. The first object is a three-dimensional object. An identification of a user of a payment device is received. A stored image of a second object is obtained. The second object is an authentication object that is assigned to the user. The user of the payment device is authenticated using the scanned image of the first object and the stored image of the second object. If the user is authenticated, a purchase of one or more goods or services is authorized using the payment device.

### BACKGROUND

Payment cards such as credit cards and debit cards are routinely used to make purchases at retail stores and other locations. However, payment cards can be lost or stolen and counterfeit copies of payment cards can be made. Possession of a payment card cannot always be relied upon to authenticate the user of the payment card. In addition, when digital payment methods such as Apple Pay are used, a physical payment card is not required.

Various methods can be used to authenticate a user when a purchase is being made. For example, a clerk can verify a signature on the back of a payment card or the clerk can ask for additional identification from the user. However, retail personnel are not always vigilant in requesting identification. In addition, some methods of authenticating the user, such as by comparing the user's signature at a time of purchase with the signature on the back of the payment card, aren't always reliable. Further, for digital payment methods, additional authentication mechanisms may be required.

### SUMMARY

Embodiments of the disclosure are directed to an electronic computing device comprising: a processing unit; and system memory, the system memory including instructions which, when executed by the processing unit, cause the electronic computing device to: receive a scanned image of a first object, the first object being a three-dimensional object; receive an identification of a user of a payment device; obtain a stored image of a second object, the second object being an authentication object that is assigned to the user; authenticate the user of the payment device using the scanned image of the first object and the stored image of the second object; and if the user is authenticated, authorize a purchase of one or more goods or services using the payment device.

In another aspect, a computer-readable data storage memory includes instructions that, when executed by a processing unit of an electronic computing device, cause the processing unit to: receive a scanned image of a first object; receive an identification of a user of a payment device; obtain a stored image of a second object, the second object being an authentication object that is assigned to the user; receive a first location of the payment device; receive a second location of the first object; determine a distance between the payment device and the first object; when the distance between the payment device and the first object is less than or equal to a predetermined limit, authenticate the user of the payment device by comparing the scanned image of the first object with the stored image of the second object; and if the user is authenticated, authorize a purchase of one or more goods or services using the payment device.

In yet another aspect, a method includes: a computer-readable data storage memory comprising instructions that, when executed by a processing unit of an electronic computing device, cause the processing unit to: receive a scanned image of a first object, the first object being an authentication token assigned to a user of a payment device, the first object being a three-dimensional object; receive an identification of the user of the payment device, the identification of the user obtained from the payment device; obtain a stored image of a second object from a data store, the second object being the authentication token that is assigned to the user; obtain a digital definition file for the second object, the digital definition file including a description and a location of a unique identifying area included on the second object, the unique identifying area comprising a scarred, blemished, unique or intentionally patterned area on the second object; authenticate the user of the payment device using the scanned image of the first object and the stored image of the second object, the authentication of the user of the payment device comprising determining whether the unique fingerprint included on the second object can be found on the first object; if the user is authenticated, authorize a purchase of one or more items using the payment device; if the user is not authenticated, deny an authorization for the purchase of the one or more goods or services using the payment device; and request additional authentication information from the user.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a custom three-dimensional financial services object.

FIG. 2 shows another example system that supports a custom three-dimensional financial services object.

FIG. 3 shows yet another example system that supports a custom three-dimensional financial services object.

FIG. 4 shows example modules that can be used to create an authentication object for a user.

FIG. 5 shows example modules of the financial institution server computer of FIG. 1.

FIG. 6 shows a flowchart of an example method for authenticating a user of a payment device.

FIG. 7 shows a flowchart of another example method for authenticating a user of a payment device.

FIG. 8 shows example physical components of the financial institution server computer of FIG. 1.

### DETAILED DESCRIPTION

The present disclosure is directed to systems and methods for using a three-dimensional object to authenticate a user when the user makes a purchase at a retail store or other location. The three-dimensional object is also referred to herein as an authentication token.

In some examples, the three-dimensional object can have a unique area on the object that can be used to authenticate the user. In other examples, the three-dimensional object can include an electronic device, such as an electronic chip, that can be used to authenticate the user. In other examples, a combination of authentication using the object, the unique area of the object and the electronic chip can be used.

The three-dimensional object can be fabricated using a three-dimensional printer or other means. In some examples, when a retail location or financial institution has an operational three-dimensional printer, the user can select an object to be fabricated from a list or menu of tokens and can have the object fabricated using the three-dimensional printer at the retail location or financial institution. In other examples, the user can provide a personal three-dimensional object, for example a house key, a keychain with a miniature football, a unicorn charm on a bracelet or necklace, etc. and identify a unique part of the selected three-dimensional object. For example, the unicorn may have a distinct feature, for example a broken or missing part that can be used as an identifier for the user. The three-dimensional printer can use multiple materials and colors.

In some examples, when the three-dimensional object is fabricated, an area of the object can be intentionally scarred, blemished or patterned in a unique way. For example, if the user selects a common object as an authentication token, when the object is fabricated a scar or blemish can be embedded into the object that uniquely identifies the object. The scar or blemish comprising the unique identifier is sometimes known as a fingerprint on the object. The fingerprint can be associated with the user for authentication purposes. As an example, if the user selects a miniature car for an object, a unique blemish can be put on the miniature car's hood that can be associated with the user and identify the user. In some cases, the blemish can be hidden from normal view (i.e., is difficult or impossible to view with the naked eye), but can be identified by a scanning device.

In some examples, the selected object is something the user would carry in a nonintrusive manner. For example, the object can be a keychain or other small trinket, for example a reward card fob that has a unique shape or pattern that can be carried in a wallet or keychain. The reward card fob can combine both authentication and rewards for a purchase. By selecting a normal object, a third party many not realize that the object functions as an authentication device. This provides enhanced security, in that the object blends in with the user such that a third party does not even realize that the object performs an authentication function.

When the user makes a purchase with a payment device, the object can be scanned to authenticate the user before the purchase is approved. In some examples, the object can be scanned by a software application on the user's smartphone. In other examples, the object can be scanned by an object scanner that is part of or associated with a POS device or an automatic teller machine (ATM). The scanner can be a three-dimensional scanner or a camera that takes pictures at specific angles. In some examples, when the object is scanned, an image of the object is sent to a server computer at a financial institution associated with the payment device. The server computer can compare the image of the object with an image on file for the user. The server computer can then authenticate the user and authorize the purchase with the payment device.

For cases where the server computer cannot authenticate the user based on the scanned image of the object, the server computer can either deny authorization or can indicate to retail personnel that additional identification is required before the user can be authorized to make the purchase. For example, the server computer can require that the user answer one or more authentication questions before being authorized to make the purchase. As another example, the server computer can prompt the user with a question about the object, for example is it a horse, is it blue, does it have a front leg missing, etc.

In other examples, instead of sending the image of the object to the server computer, the scanned image can be identified using a software application on the scanning device. For example object recognition software on a smartphone can be used to compare the image of the object with an image of an authentication token assigned to the user. When the images match, the user can be authenticated to make the purchase with the payment device. The object recognition software can include facial recognition type algorithms.

In some examples, the object can include an electronic device such as an electronic chip or a radio frequency identification (RFID) tag. The electronic chip can contain electrodes, communication and sensing technologies. When the object includes the electronic device, the object can communicate directly to another electronic device. For example, the object can use Bluetooth functionality to communicate with the POS device, the ATM, the smartphone or other devices that include Bluetooth or similar Wi-Fi functionality. For example, if an automobile includes Bluetooth or similar functionality and the object is in range of the automobile (for example within 30 feet of the automobile), the object can communicate with the automobile. The automobile may have an additional communication link that can be used to communicate to the server computer. As an example, the automobile can function as a beacon, transmitting a unique code.

In some examples, the electronic device can comprise stretchy electronic circuits (smart fabrics) that can overlay parts of the authentication object. The stretchy electronic circuits can include sensors that can detect pressure, heat, light, acceleration and smell. In some implementations, the sensors can detect human body metrics such as pulse, blood flow, heart rate pattern, etc. The electronic chip and the stretchy electronic circuits can be powered by various means, such as a battery, solar power, and/or body heat from the user. The stretchy electronic circuits can also include electrodes and communication technologies.

In some examples, the object can communicate directly to the server computer. As discussed in more detail later herein, a determination can be made as to a distance between the object and the user and when the distance between the object and the user is greater than a predetermined threshold, the user is denied authentication. For example, if the user were to leave the authentication object in the user's car and a determination is made that a distance between the user at a retail location and the authentication object is greater than the predetermined distance, the user may be prevented making purchases with the user's payment card or with a digital payment software application, such as Apple Pay. As discussed later herein, the distance between the object and the user can be obtained by determining the distance between the object and something else on the user, like the user's smartphone.

In some examples, the object can transmit user body metric data to the server computer. The server computer can determine whether the transmitted body metric data matches body metric data on file for the user. A match of the transmitted body metric data combined with an identification of the authentication token can be used to authenticate the user.

In some examples, the user can be prompted to provide an image of the authentication object. The prompts can be application prompts or text messages to a smartphone or other mobile electronic device. The images can be sent to the server computer for comparison with stored image files, avatars or metadata descriptions.

The systems and methods can also be used for non-financial applications. For example, the systems can be used in a high security area of a building as an additional authentication check for an individual requesting access to the high security area of the building. In this example, in addition to requiring an employee badge or other type of identifier to gain access to the high security area, the individual would also need to be authenticated using an authentication token. Using the authentication token provides an additional level of security to prevent authorized access if the employee badge or other type of identifier is stolen. Other non-financial uses are possible.

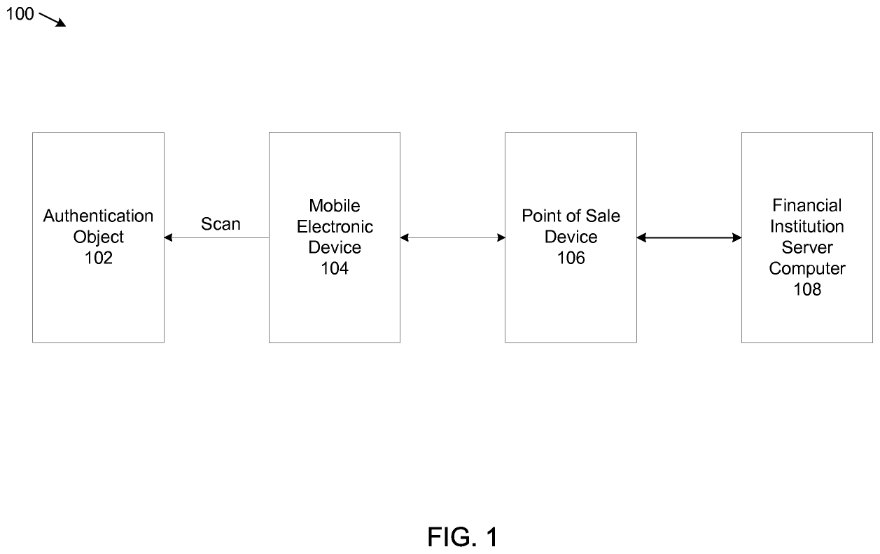

FIG. 1 shows an example system 100 in which an authentication object can be used to authenticate a user prior to making a purchase. The example system 100 includes an authentication object 102, a mobile electronic device 104, a POS device 106 and a financial institution server computer 108.

The example authentication object 102 can be any object that the user chooses as an authentication token to authenticate the user when making purchases. As discussed, the authentication object 102 can be a personal object of the user, for example a keychain, or an object that the user can select from a catalog of authentication objects offered by a financial institution. When the user selects an authentication object from the financial institution, the authentication object can be fabricated with a three-dimensional printer. In some examples, the three-dimensional printer can be located at a branch of the financial institution. In other examples, the three dimensional printer can be located at a retail store. In other examples, the three-dimensional object can be located at a third party manufacturing facility. Other locations are possible.

When the authentication object is a personal object of the user, a determination is made as to whether there are any unique identifying features on the object. When a unique identifying feature can be located on the object, the unique identifying feature can be scanned and entered into a record for the user at the financial institution. The record can include a description and a location for the unique identifying feature. When a unique identifying feature cannot be located on the object, for example, if the object is a house key and there are no unique features on the house key that can uniquely identify the user, the user may be asked to choose another object or select an authentication token to be fabricated. A unique pattern or fingerprint can then be added to the object during fabrication, for example when printed using a three-dimensional printer. Alternatively, depending upon the object, one or more unique identifying features can be added to the object. For example, engraved letters or numbers, a color, a sticker or something similar that can be removed without materially harming the object can be added to the object. Other identifying features that can be added to the object can include varying hole sizes, pattern punched holes or notches. Additional identifying features are possible.

When the authentication token is selected from a catalog of objects and is fabricated by a three-dimensional printer, a unique blemish or scarring can be added to the object during fabrication. The unique blemish or scarring comprises a fingerprint for the object that can be used to identify the object during authentication. In some examples, the fabricated object can comprise a payment card or other object with depressed areas or raised dots such as “braille.”

The example mobile electronic device 104 is a mobile electronic computing device such as a smartphone or tablet computer. The mobile electronic device 104 can include a software application from the financial institution server computer 108 and a camera. The camera can be used to scan the authentication object 102. After the authentication object 102 is scanned, the mobile electronic device 104 can be placed against an image scanner at the POS device 106 and the scanned image of the object can be processed by the POS device 106. In some examples, the POS device 106 can send the scanned image of the object directly to financial institution server computer 108. In other examples, the software application can include a capability of analyzing the scanned image of the object and identifying and authenticating the object from the scanned image of the object using object recognition software.

The POS device 106 is a point of sales device at a retail establishment. The POS device 106 commonly includes a payment card reader in which a payment card can be processed. The POS device 106 can also include a reader device for inputting scanned images from a smartphone. The user can scan an image of the authentication object 102 with the smartphone and then place the smart phone against the reader device. In some examples, the POS device 106 can include a scanner (e.g., video camera or other device) that can be used in lieu of the smartphone to scan the authentication object 102.

Identification information for the user from the payment card and the scanned image of the authentication object can both be sent to the financial institution server computer 108. The financial institution server computer 108 can then authenticate the user and authorize a user transaction at the POS device 106.

In some examples, the software application on the mobile electronic device 104 can include electronic payment capability, such as Apple Pay, in which the mobile electronic device 104 can be used as a payment device. In these examples, the POS device 106 can process both the user identification information and the scanned image of the authentication object from the mobile electronic device 104 and send both the identification information and the scanned image to the mobile electronic device 104.

The example financial institution server computer 108 is a server computer at a financial institution such as a bank, a credit card company, a financial services company, etc. The financial institution server computer 108 stores or has access to profile records and transaction histories for a plurality of customers of the financial institution. One or more of the customers can have payment accounts, including one or more of credit cards, debit cards and rewards cards at the financial institution. In addition, a digital definition file can identify authentication objects that are associated with the payment accounts, including unique fingerprints associated with the authentication objects. The financial institution server computer 108 also includes object recognition software that can compare an authentication object image received from POS device 106 with an authentication object image on file for a user. The object recognition software can identify any fingerprints in the object images and make a determination as to whether the user should be authenticated for purchases using the payment card.

More than one financial institution server computer 108 can be used. In addition, one or more of the profile records, transaction histories and other information associated with the user can be stored and accessed on one or databases or on other server computers that are accessible from financial institution server computer 108.

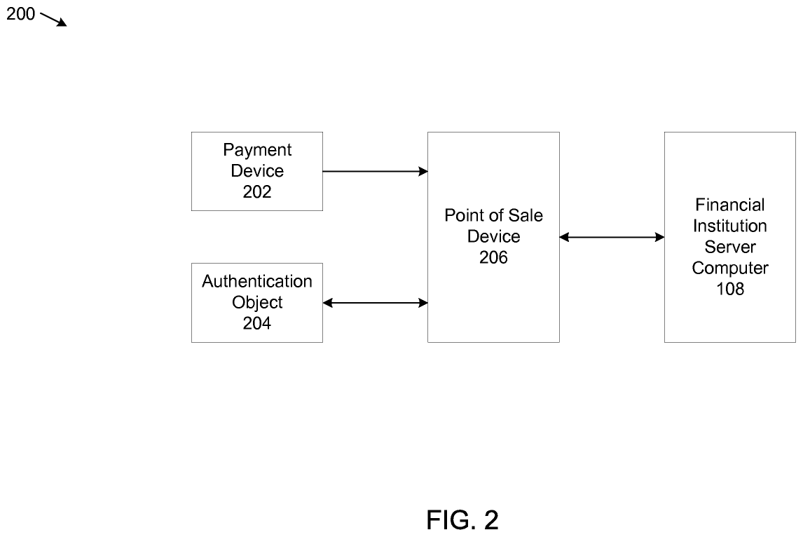

FIG. 2 shows another example system 200 in which an authentication object can be used to authenticate a user prior to making a purchase. The example system 200 includes a payment device 202, an authentication object 204, a POS device 206 and the financial institution server computer 108. The example system 200 implements a payment scenario whereby the authentication object 204 can communicate directly to the POS device 206 to authenticate the user.

For system 200, the authentication object 204 includes an electronic chip or RFID device. The electronic chip can be embedded in authentication object 204 when the authentication object 204 is fabricated. The RFID device can be attached to authentication object 204 after fabrication. The electronic chip or RFID device permits direct communication between authentication object 204 and POS device 206. The electronic chip or RFID device can send a unique identifier for authentication object 204 to the POS device 206. The unique identifier can then be sent to the financial institution server computer 108, along with identification information from the payment device 202 to authenticate the user. The unique identifier can verify that the authentication object 204 is assigned to the user and can also verify that the authentication object 204 is at a same physical location as the POS device 206. The authentication object 204 can communicate with the POS device 206 using a short range communication technology such as Bluetooth or near-field communication (NFC).

The example payment device 202 can either be a payment card, such as a credit card or a debit card, or a mobile electronic device such as a smartphone having an electronic payment software application. When the payment device 202 is a payment card, user identification information from a magnetic stripe or other identification means on the payment card is sent to POS device 206. When the payment device 202 is a mobile electronic device, the electronic payment software application on the mobile electronic device communicates with POS device 206. User identification information is sent from the mobile electronic device to POS device 206. The payment device 202 can also be other devices that are used to make payment for goods and/or services.

The example POS device 206 is a point of sales device at a retail location. The POS device 206 can be the same as POS device 106 or the POS device 206 can be different from POS device 106. The POS device 206 can include a reader for the payment device 202. For example, the POS device 206 can include a contactless reader for a payment application for the payment device 202 such as Apple Pay. The POS device 206 can also include electronics to interface with and communicate with the authentication object 204. In addition, the POS device 206 can include a magnetic stripe reader for a traditional payment card, such as a credit card or a debit card. Other types of devices can also be used at the retail location. For example access type devices such as badge, license and card readers can be used to scan barcodes or UPC codes that identify the user. Items that can be scanned can include driver's licenses, airline passes, tickets and other such items.

For system 200, the financial institution server computer 108 is the same financial institution server computer as for system 100, although other financial institution server computers can be used. For system 200, financial institution server computer 108 receives user identification information and authentication information from POS device 206 and determines whether to authenticate the user for a purchase with payment device 202. The identification information is obtained from the payment device, for example from the magnetic stripe on a payment card. The authentication information can comprise the unique identifier sent to POS device 206 from the authentication object 204.

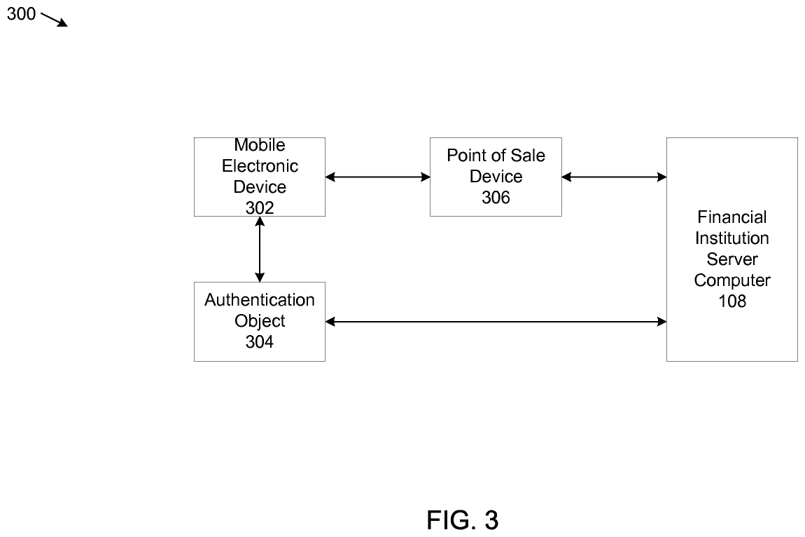

FIG. 3 shows yet another example system 300 in which an authentication object can be used to authenticate a user prior to making a purchase. The example system 300 includes a mobile electronic device 302, an authentication object 304, a POS device 306 and the financial institution server computer 108. The example system 300 implements a payment scenario whereby the authentication object 304 can communicate directly to the financial institution server computer 108 to authenticate the user.

The example mobile electronic device 302 is a mobile electronic computing device such as a smartphone or a laptop computer. The mobile electronic device 302 can include a payment application such as Apple Pay that can permit the mobile electronic device 302 to be used in lieu of a payment card for purchases. The mobile electronic device 302 can also include software than can permit communications with the authentication object 304.

The example authentication object 304 can include an electronic device that can not only permit the authentication object 304 to communicate with the mobile electronic device 302 but that can also permit the authentication object 304 to communicate via the Internet to the financial institution server computer 108 and to other authentication objects. The electronic device can be an electronic chip that is embedded into authentication object 304 when the authentication object 304 is fabricated. The electronic device can also be an electronic device that can be manually attached to the authentication object 304, for example an electronic sticker that can be attached to the authentication object 304.

The electronic device can broadcast a signal that can permit the authentication object 304 to be remotely located. The signal can also permit a determination as to how far the authentication object 304 is from mobile electronic device 302. In some examples, the authentication object 304 may need to be within a certain predetermined distance from the mobile electronic device 302 in order for a purchase to be made using the mobile electronic device 302. In some examples, when authentication object 304 is at a distance from mobile electronic device 302, authentication object 304 can turn itself off, preventing additional purchases with mobile electronic device 302. When the authentication object 304 is greater than another predetermined distance from the mobile electronic device 302, the authentication object 304 can communicate to the financial institution server computer 108 that the authentication object 304 is lost. The financial institution server computer 108 can maintain a database of all authentication objects and include a status for each authentication object, indicating whether an authentication object is lost or is available for use.

In addition, authentication object 304 can communicate marketing information to the financial institution server computer 108. For example, the authentication object 304 can communicate the identity of retail stores in which the user likes to shop. The marketing information can permit the financial institution to issue coupons to the user when the user is shopping at a particular retail store. As another example, the marketing information can permit the financial institution to provide better deals to the user on certain purchases such as new cars and boats, etc.

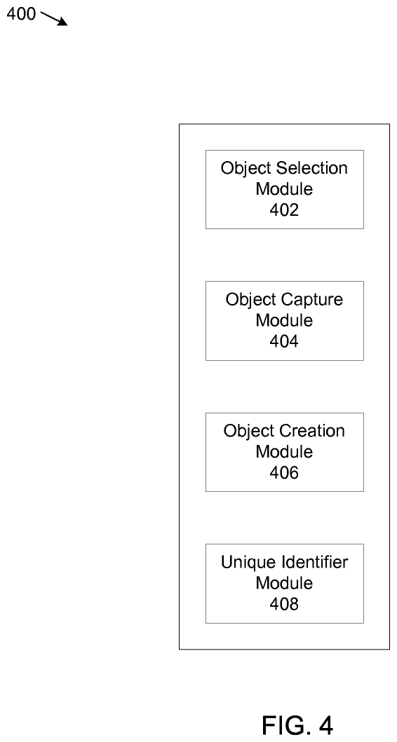

FIG. 4 shows example modules 400 that can be used to create an authentication object for a user. The example modules include an object selection module 402, an object capture module 404, an object creation module 406 and a unique identifier module 408. More, fewer or different modules can be used.

The example object selection module 402 processes a selection of the authentication object for the user. When the user provides a personal object that is to be used as the authentication object, the object selection module 402 can assign the personal object as the authentication object for the user. When the user does not want to use a personal object as the authentication object, the object selection module 402 permits the user to select an authentication object from a plurality of available authentication objects. In one example, the user can access a website at or associated with the financial institution, view a catalog or list of available authentication objects and choose an authentication object from the catalog or list. When the user selects the authentication object, the object selection module 402 can assign the selected authentication object to the user. In an example implementation, the object selection module 402 can be located on the financial institution server computer 108.

The example object capture module 404 can be used to capture an image of the authentication object when the authentication object is a personal object of the user. The image can be captured after a photograph is taken of the personal object. As discussed earlier herein, when the personal object does not have any unique identifying features, the captured image of the personal object can be scarred, blemished or intentionally patterned to create a unique identifying feature for the personal object. For example, one eye can be made bigger on a captured image of a cat keychain or one ear can be made shorter, or a scratch can be made between the eyes of the captured image. In an example implementation, the object capture module 404 can be located on a smartphone. An image of the personal object can be captured using a camera on the smartphone and the image can be sent to the financial institution server computer 108.

The image captured by the object capture module 404 can be a three-dimensional image obtained by doing a three-dimensional scan of the object and storing a three-dimensional object file. The image captured by the object can also be a conventional two-dimensional image obtained by a scanner or camera. In addition, when a personal object is scanned by a three-dimensional scanner, a resulting computer aided design (CAD) file can be used to duplicate the personal object on a three-dimensional printer. The duplication of the object on the three-dimensional printer can also include any modifications needed to create a unique fingerprint for the object when printed on the three-dimensional printer.

The object capture module 404 can capture both an image of the object that can identify the object and an image of the unique fingerprint on the object. The object capture module 404 can create one or more digital definition files for the object. The one or more digital definition files can describe characteristics of the object, such as size, shape and color. The one or more digital definition files can also include information regarding a location and description of the unique identifying area on the object that comprises the unique fingerprint for the object. In some implementations the information regarding the object and the unique fingerprint can all be included in one digital definition file. In other implementations, there can be a separate digital definition file for the object and another digital definition file for the fingerprint. For a two-dimensional image, one or more of the digital definition files can include information regarding a three-dimensional view of the object.

The example object creation module 406 can be used to fabricate a three-dimensional authentication object based on a selection of an authentication object by the user. As discussed above herein, the user can select the authentication object from a catalog or list of available authentication objects. A three-dimensional printer can be used to fabricate the authentication object. The object creation module 406 can provide direction to the 3-dimensional printer when the object is fabricated. In addition, during fabrication, the object creation module 406 can add a scar or blemish to the authentication object as a way to provide a unique identifying feature for the authentication object. In some examples, the object creation module 406 can randomly generate the scar or blemish. The object creation module 406 can also use multiple colors as a way to provide a unique identifying feature for the authentication object.

In some examples, the object creation module 406 can create a unique digital avatar from a physical object. The digital avatar can be stored and used to create a three-dimensional print file for the three-dimensional printer. The object creation module 406 can instruct the three-dimensional printer to fabricate an authentication object that matches the digital avatar.

In an example implementation, the object creation module 406 can be located on the three-dimensional printer. In another example implementation, the object creation module 406 can be located on the financial institution server computer 108 and communicate with the three-dimensional printer during fabrication of the authentication object.

The example unique identifier module 408 can identify a unique feature on the authentication object and update a digital definition file with information regarding the unique feature. The information can include both data, for example an image of the unique feature, and metadata, for example a description of the unique feature, a location of the unique feature on the authentication object, and a date and time at which the unique feature was created. Other metadata is possible. In an example implementation, the unique identifier module 408 can be located on the financial institution server computer 108.

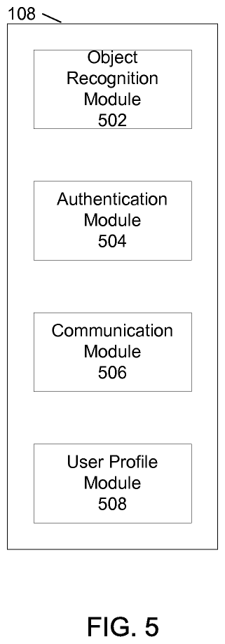

FIG. 5 shows example modules of the financial institution server computer 108. The example financial institution server computer 108 includes an object recognition module 502, an authentication module 504, a communication module 506 and a user profile module 508. Other modules, for example modules discussed in regard to FIG. 4, are possible.

The example object recognition module 502 includes functionality to analyze picture or scanned images and to compare image files. The object recognition module 502 can access an image file of an authentication object assigned to a user and compare the image file of the authentication object assigned to the user with a scanned image file of the object that is obtained from a POS device. The object recognition module 502 can identify a unique fingerprint on each object and make a determination as to whether the unique fingerprint on the authentication object assigned to the user matches the unique fingerprint on the scanned image of the object. When the unique fingerprints match, the authentication module 504 can authenticate the user.

The example authentication module 504 can authenticate the user for a purchase using a payment device when the object recognition module 502 indicates that there is a match between the unique fingerprint on the authentication object assigned to the user and the unique fingerprint on the scanned image of the object, as discussed above herein. The authentication module 504 can also authenticate the user for a purchase using a payment device upon receiving an identifier from an authentication object and determining that the authentication object is within a predetermined distance from the payment device. As discussed later herein, the identifier from the authentication object can be obtained in a direct communication between the authentication object and the communication module 506. Other examples in which the authentication module 504 can authenticate the user are possible.

The example communication module 506 permits communication between the financial institution server computer 108 and a POS device at a retail location. The financial institution server computer 108 can receive identification information for a user for a purchase from the POS device and can also receive a scanned image of an authentication object from the POS device. When the user is authenticated, the communication module 506 can send a message to the POS device indicating that the user is authenticated.

The communication module 506 can also communicate directly with the authentication object. The authentication object can send a message to the communication module 506. In one example, the message can include both an identifier for the authentication object and a global positioning system (GPS) location of the authentication object. The communication module 506 can also receive a message from a POS device that includes an identifier for a user and a GPS position of a payment device. The authentication module 504 can use the GPS position of the payment device and the GPS position of the authentication object to determine whether the authentication object is less than a predetermined distance from the payment device. When the authentication module 504 determines that the authentication object is within the predetermined distance from the payment device and when the authentication module determines that the identity of the user matches an identity of a user assigned to the authentication object, the authentication module 504 can authenticate the user for a purchase using the payment device. The communication module 506 can then send a message to the POS device indicating that the user is authenticated to make the purchase.

In some examples, in addition to or in lieu of providing the GPS location of the authentication object, the message from the authentication object can include body metrics, such as heart rate, blood flow, sweat or smell characteristics of the user. Use of body metrics in addition to the location of the authentication object and the unique identifier for the authentication object can permit a multi-factor authentication of the user.

The example user profile module 508 stores profile information for customers of the financial institution. The profile information can include an identifier for the customer, contact information for the customer and information regarding an authentication object that is assigned to the customer. The information regarding the authentication object that is assigned to the customer can include a digital definition file for the user. The digital definition file can include an image of the authentication object that is assigned to the user and information regarding a location and description of a unique fingerprint that may be associated with the authentication object. As discussed earlier herein, the authentication object can be selected from a catalog of available authentication objects or the authentication object can be a personal object of customer or a copy of a personal object.

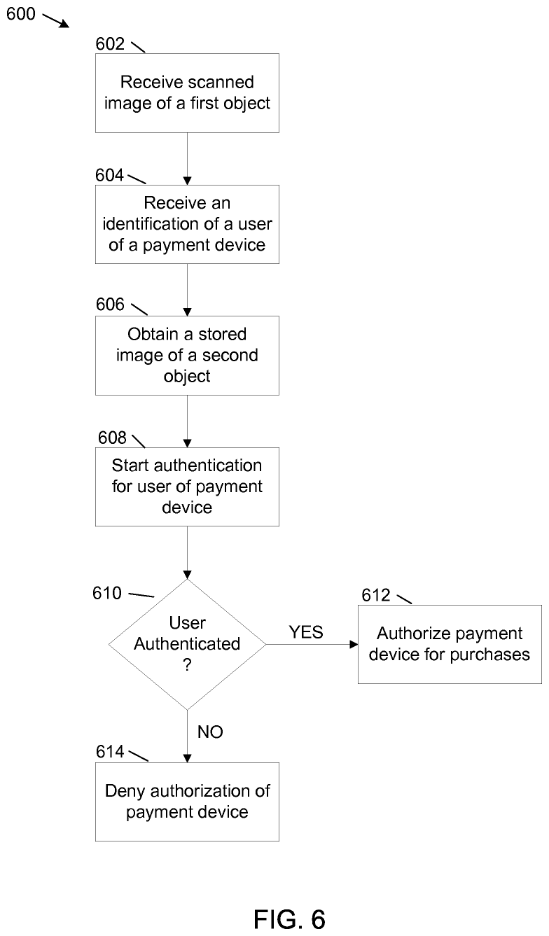

FIG. 6 shows a flowchart of an example method 600 for authenticating a user of a payment device. For method 600, the payment device can be a payment card, such as a credit card or a debit card, or the payment device can be a mobile electronic device, such as a smartphone, having a software application such as Apple Pay for making purchases using the mobile electronic device.

At operation 602, a scanned image of a first object is received at financial institution server computer 108. The first object is an authentication token for the user of the payment device. The authentication token is an object assigned to the user by the financial institution to be used as an authentication mechanism when making purchases using the payment device. The authentication token can be an object, such as a house key supplied by the user, or the authentication token can be selected by the user from a catalog or list of authentication tokens made available by the financial institution.

When the authentication token is selected by the user, the authentication token is generally fabricated, for example using a three-dimensional printer. During fabrication, a unique scarring pattern or blemish can be added to the authentication token to uniquely identify the authentication token. A data definition file can be created when the authentication token is fabricated. The data definition file can include data and metadata that describes the scarring pattern or blemish and specifies a location of the scarring pattern or blemish on the authentication token. The scarring pattern or blemish can also be referred to as a unique fingerprint for the authentication token.

When the payment device is a mobile electronic device with a camera, the scanned image of the first object can be obtained by taking a picture of the first object with a mobile electronic device in a personally known specific location relative to the first object. When an image of the first object is displayed on the mobile electronic device, the mobile electronic device can be placed on an image reader that is part of a POS device. The POS device can be a POS device at a retail location at which the user is making a purchase of an item. The scanned image of the first object on the mobile electronic device can be input to the POS device and sent to financial institution server computer 108.

When the payment device is a payment card, such as a credit card or a debit card, if the user also has a mobile electronic device the scanned image of the first object can be obtained by taking a picture of the first object with the mobile electronic device. Alternatively, when the POS device includes a scanning device, the first object can be scanned by the scanning device.

At operation 604, an identification of the user of the payment device is received at the financial institution server computer 108. When the payment device is a payment card, the identification can be obtained from a magnetic stripe on the payment card when the payment card is swiped at the POS device. When the payment device is a mobile electronic device with a payment software application, the identification can be obtained from an identifier for the user that can be stored on the payment device.

At operation 606, an image of a second object is obtained at the financial institution server computer 108. The image can be obtained from a data store on the financial institution server computer 108 or accessible from the financial institution server computer 108. The image is identified on the data store from the identification for the user obtained at operation 604. The image of the second object is an image of the authentication token that is assigned to the user. The authentication token can be assigned to the user when the user obtains a payment card at the financial institution or when the user opens one or more accounts at the financial institution. The image of the second object includes the unique fingerprint on the authentication token.

At operation 608, an authentication process is started for the user of the payment device. The authentication process comprises using object recognition software on the financial institution server computer 108 to compare the received scanned image of the first object with the image of the second object. The object recognition software uses a data definition file for the second object to determine where the unique fingerprint is located on the first and second objects. The authentication process determines whether the scanned image of the object contains the unique fingerprint and whether the unique fingerprint matches the fingerprint on the second object. The authentication process also uses a data definition file to identify the entire first object, including the fingerprint. When a comparison of the entire image of the first object with the second object and a comparison of the unique fingerprint indicates that the first object matches the second object, the user is authenticated.

At operation 610, a determination is made as to whether the user is authenticated. When a determination is made that the user is authenticated, at operation 612, the user is authorized at the POS device to make purchases of goods or services using the payment device. When a determination is made that the user is not authenticated, at operation 614, the user is denied authorization to make purchases with the payment card at the POS device. In some examples, when the user is not authenticated, the user is required to supply additional authentication information before the user can become authorized to make purchases using the payment card. The additional information can include one or more of answers to security questions, providing additional identification such as a driver's license, having an email sent to the user with a password that the user needs to enter, or other identification.

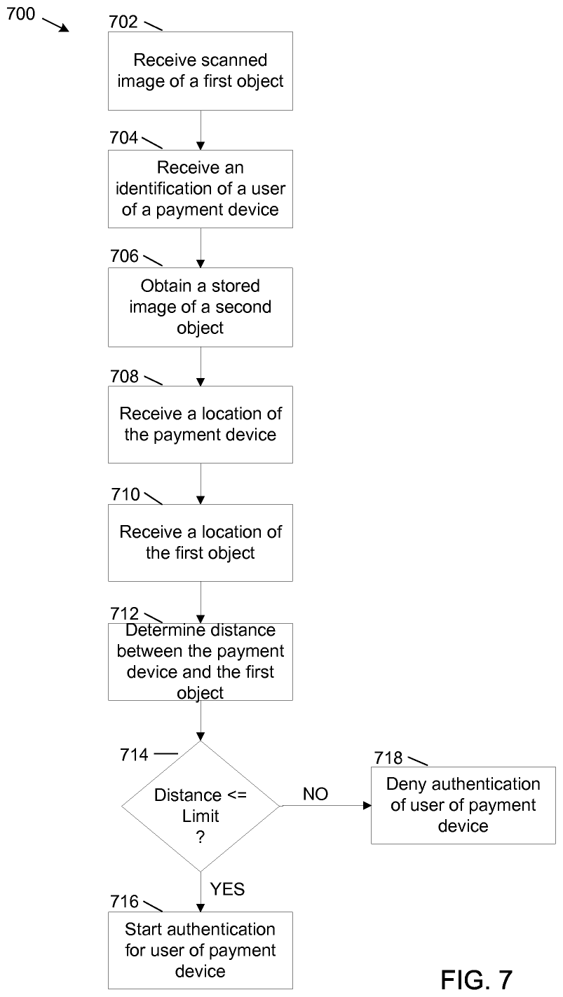

FIG. 7 shows a flowchart of another example method 700 for authenticating a user of a payment device. Method 700 is similar to method 600. However, method 700 adds another level of authentication to method 600. With method 700, before the scanned image of the first object is compared with the stored image of the second object, the first object needs to be within a predetermined distance from the user. This ensures that the payment device and the authentication token are in the same physical location before the user is authenticated to make a purchase using the payment card.

Operations 702, 704 and 706 are identical to operations 602, 604 and 606 respectively. At operation 702, a scanned image of the first object (the authentication token) is received at financial institution server computer 108. At operation 704, identification for a user of a payment device is also received at financial institution server computer 108. At operation 706, a stored image of a second object (a stored image of an authentication token assigned to the user) is obtained from a data store.

At operation 708, a location of the payment device is received at financial institution server computer 108. When the payment device is a mobile electronic device such as a smartphone, the location of the payment device can be obtained from GPS software on the smartphone. Alternatively, in some examples the location of the payment device can be obtained from a location of the POS device where the payment device is being used.

At operation 710, a location of the first object is received at financial institution server computer 108. In some examples, the first object (authentication token) can include an electronic device with Bluetooth or similar short range communication functionality. In these examples, the first object can use GPS software on the electronic device to communicate a location of the first object to a mobile electronic device of the user. The mobile electronic device can then send the location of the first object to financial institution server computer 108. Alternately, when the POS device includes Bluetooth or similar short range communication functionality, the first object can send the location of the first object to the POS device and the POS device can send the location of the first object to the financial institution server computer 108.

In other examples, the first object can include an embedded electronic device that includes Internet connection functionality. In these examples, the first object can use GPS software on the electronic device to communicate a location of the first object directly to financial institution server computer 108.

At operation 712, financial institution server computer 108 uses the location of the payment device and the location of the first object to determine a distance between the payment device and the first object.

At operation 714, a determination is made as to whether the distance between the payment device and the first object is less than or equal to a predetermined threshold distance. In some examples, the threshold distance can correspond to a transmission range for the short range communication functionality. For example, the predetermined threshold distance can be 30 feet.

When a determination is made at operation 714 that the distance between the payment device and the first object is greater than the predetermined threshold distance, at operation 718, authentication of the payment device for the user is denied.

When a determination is made at operation 714 that the distance between the payment device and the first object is less than or equal to the predetermined threshold distance, at operation 716, an authentication process is started for the user of the payment device. The authentication process comprises using object recognition software on the financial institution server computer 108 to compare the received scanned image of the first object with the image of the second object. The object recognition software uses a data definition file for the second object to determine where the unique fingerprint is located on the first and second objects. The authentication process determines whether the scanned image of the object contains the unique fingerprint and whether the unique fingerprint matches the fingerprint on the second object. When the comparison indicates that the first object matches the second object, the user is authenticated.

When the user is authenticated, the user is authorized for purchases with the payment device, as per operation 612 of method 600. When the user is not authenticated, the user is denied authorization of the payment device, as per operation 614 of method 600.

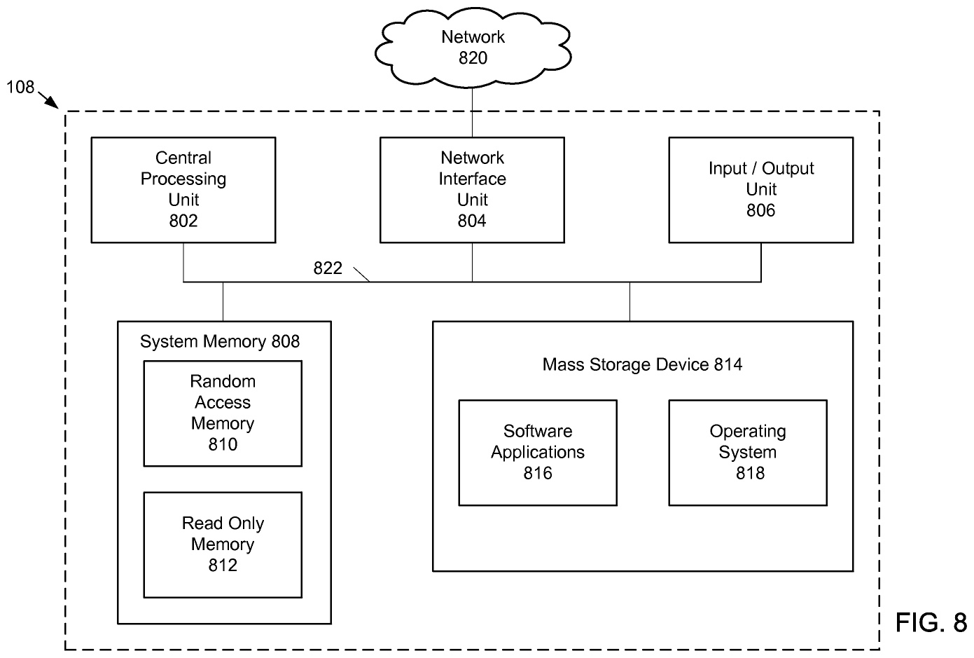

As illustrated in the example of FIG. 8, financial institution server computer 108 includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the financial institution server computer 108, such as during startup, is stored in the ROM 812. The financial institution server computer 108 further includes a mass storage device 814. The mass storage device 814 is able to store software instructions and data. Some or all of the components of the financial institution server computer 108 can also be included in mobile electronic devices 104 and 302, payment device 202, authentication objects 102, 204 and 304, and POS devices 106, 206, and 306.

The mass storage device 814 is connected to the CPU 802 through a mass storage controller (not shown) connected to the system bus 822. The mass storage device 814 and its associated computer-readable data storage media provide non-volatile, non-transitory storage for the financial institution server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 108.

According to various embodiments of the invention, the financial institution server computer 108 may operate in a networked environment using logical connections to remote network devices through the network 820, such as a wireless network, the Internet, or another type of network. The financial institution server computer 108 may connect to the network 820 through a network interface unit 804 connected to the system bus 822. It should be appreciated that the network interface unit 804 may also be utilized to connect to other types of networks and remote computing systems. The financial institution server computer 108 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the financial institution server computer 108 can store software instructions and data. The software instructions include an operating system 818 suitable for controlling the operation of the financial institution server computer 108. The mass storage device 814 and/or the RAM 810 also store software instructions, that when executed by the CPU 802, cause the financial institution server computer 108 to provide the functionality of the financial institution server computer 108 discussed in this document. For example, the mass storage device 814 and/or the RAM 810 can store software instructions that, when executed by the CPU 802, cause the financial institution server computer 108 to display received data on the display screen of the financial institution server computer 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. An electronic computing device comprising:
a processing unit; and
system memory, the system memory including instructions which, when executed by the processing unit, cause the electronic computing device to:
receive a scanned image of an object from a user device, the object being a three-dimensional user authentication token that is fabricated to include a radio frequency identification (RFID) device and that includes a unique identifying area, the unique identifying area being an imperfection that is embedded into the three-dimensional object when the three-dimensional object is fabricated;
receive an identification of a user of the user device;
receive, as an electronic signal from the RFID device, an identifier for the object;
transmit the identifier for the object and the identification of the user to a server;
receive, from the server, verification that the object is assigned to the user;
based on the electronic signal from the RFID device, determine a current location of the object;
receive a current location of the user device;
determine whether the current location of the object is within a predetermined distance from the current location of the user device;
obtain a stored image of the object; and
when the location of the object is within the predetermined distance from the location of the device, authenticate the user of the user device by comparing the scanned image of the object and the stored image of the object based on:
the current location of the object being within the predetermined distance from the current location of the user device;
the scanned image of the object including the unique identifying area and the unique identifying area matching a unique identifying area of the stored image; and
the verification that the object is assigned to the user.

2. The electronic computing device of claim 1, wherein if the user is not authenticated, the instructions further cause the electronic computing device to:
request additional authentication information from the user.

3-4. (canceled)

5. The electronic computing device of claim 1, wherein the instructions further cause the electronic computing device to store or have access to a digital definition file for the object, the digital definition file including a description and location of the unique identifying area on the object.

6. The electronic computing device of claim 5, wherein the electronic computing device uses object recognition software on the electronic computing device to compare the scanned image of the object with the stored image of the object, the user being authenticated when the object recognition software determines that the unique identifying area can be found on the scanned image of the object.

7. The electronic computing device of claim 5, wherein the electronic computing device compares the scanned image of the object with the stored image of the object, the user being authenticated when the electronic computing device determines that the unique identifying area can be found on the scanned image of the object.

8. The electronic computing device of claim 1, wherein the object was previously selected by the user to identify the user.

9. The electronic computing device of claim 1, wherein the object is fabricated on a three-dimensional printer.

10. The electronic computing device of claim 9, wherein a portion of the object is modified with a unique pattern before the object is fabricated.

11. The electronic computing device of claim 1, wherein the object is an item currently owned by the user that has one or more unique features.

12. The electronic computing device of claim 1, wherein the instructions further cause the electronic computing device to receive a message from another electronic computing device, the message containing information specifying a distance between the object and a mobile electronic device.

13. The electronic computing device of claim 12, wherein the instructions further cause the electronic computing device to:
determine whether the distance between the object and the mobile electronic device is greater than a predetermined distance; and
when the distance between the object and the mobile electronic device is greater than the predetermined distance, deny authenticating the user.

14. An electronic computing device comprising:
a processing unit; and
system memory, the system memory including instructions which, when executed by the processing unit, cause the electronic computing device to:
receive, from a user device, a scanned image of a physical three-dimensional object that is to be used as a user authentication device, the physical three-dimensional object being fabricated to include a radio frequency identification (RFID) device;
receive an identification of a user of the user device;
receive, as an electronic signal from the RFID device, an identifier for the object;
transmit the identifier for the object and the identification of the user to a server;
receive, from the server, verification that the object is assigned to the user;
obtain a stored image of the object, the object being a user authentication object that is assigned to the user;
receive a current location of the user device;
based on the electronic signal from the RFID device, determine a current object location;
determine whether a distance between the current location of the user device and the current location of the object is within a predetermined distance; and
when the distance between the device location and the object location is less than or equal to a predetermined limit, authenticate the user of the device by comparing the scanned image of the object with the stored image of the object based on:
the current location of the object being within the predetermined distance from the current location of the user device;
the scanned image of the object including the unique identifying area and the unique identifying area matching a unique identifying area of the stored image; and
the verification that the object is assigned to the user.

15. The electronic computing device of claim 14, wherein if the user is not authenticated, the instructions further cause the electronic computing device to:
request additional authentication information from the user.

16. The electronic computing device of claim 14, wherein the scanned image of the object includes a digital fingerprint for the object, the digital fingerprint identifying a scarred, blemished or intentionally patterned area of the object.

17. The electronic computing device of claim 14, wherein the instructions further cause the electronic computing device to store or have access to a digital definition file for the object, the digital definition file including a description and location of a unique identifying area on the object.

18. The electronic computing device of claim 14, wherein to authenticate the user using the scanned image of the object and the stored image of the object comprises:
identify a digital fingerprint on the scanned image of the object;
determine whether the digital fingerprint can be found in the stored image of the object; and
when the digital fingerprint can be found in the stored image of the object, authenticate the user.

19. The electronic computing device of claim 14, wherein the current location of the object is specified in a message received from the object.

20. A non-transitory computer-readable data storage memory comprising instructions that, when executed by a processing unit of an electronic computing device, cause the processing unit to:
receive a scanned image of object from a user device, the object being a user authentication token assigned to a user of the user device, the object being a three-dimensional object that is fabricated from a material using a printing process and that includes a unique identifying area, the three-dimensional object being fabricated to include a radio frequency identification (RFID) device, the unique identifying area being a scar or blemish that is embedded into the three-dimensional object when the three-dimensional object is fabricated;
receive an identification of the user of the user device, the identification of the user obtained from the user device;
based on an electronic signal from the RFID device, receive an identifier of the object and determine a current location of the object;
receive a current location of the user device;
determine whether the current location of the object is within a predetermined distance from the current location of the user device;
transmit the identifier for the object and the identification of a user to a server;
receive, from the server, verification that the object is assigned to the user;
obtain a stored image of the object from a data store, the object being the user authentication token that is assigned to the user;
obtain a digital definition file for the object, the digital definition file including a description and a location of the unique identifying area included on the object, the unique identifying area comprising a scarred, blemished, unique or intentionally patterned area on the object; and
when the location of the object is within the predetermined distance from the location of the device, authenticate the user of the device using the scanned image of the object and the stored image of the object, the authentication of the user of the device comprising determining whether a unique fingerprint included on the object can be found on the object, wherein to authenticate the user is based on:
the current location of the object being within the predetermined distance from the current location of the user device;
the scanned image of the object including the unique identifying area and the unique identifying area matching a unique identifying area of the stored image; and
the verification that the object is assigned to the user; and
if the user is not authenticated, request additional authentication information from the user.

21. The electronic computing device of claim 1, wherein the object is a first object, and wherein a second object is used to obtain the stored image.

22. The electronic computing device of claim 14, wherein the object is a first object, and wherein a second object is used to obtain the stored image.
